(19) United States
(12) Patent Application Publication
(10) Pub. No.: US 2005/0042370 A1
(43) Pub. Date: Feb. 24, 2005

(54) Kit for adding a decorative, non-skid surface to an existing surface and method for using the kit

(76) Inventors: Tracey K. McManus, Virginia Beach, VA (US); August P. Ciell, Cocoa Beach, FL (US)

Correspondence Address: WILLIAMS MULLEN, FOUNTAIN PLAZA THREE, SUITE 200, 721 LAKEFRONT COMMONS, NEWPORT NEWS, VA, 23606, US

(21) Appl. No.: 10/646,984

(22) Filed: Aug. 22, 2003

(51) Int. Cl. B05D 1/12

(52) U.S. Cl. 427/206; 427/180; 118/504

(57) ABSTRACT

A kit for applying a non-skid surface to a target surface and method for using the kit. The target surface is prepared to accept an adhesive. A mask material allows selected portions of the target surface to be selectively exposed. An adhesive is applied to the exposed portions of the target surface. A first color of aggregate material is applied to the adhesive. Additional portions of the target surface are exposed and adhesive is applied. A second color of aggregate material is applied to the additional exposed portions of the target surface. The process is repeated until all desired portions of the target surface are coated with the aggregate material in the desired design. The design may be a preformed stencil in the masking material or may be drawn in the masking material and selectively removed from the masking material to apply the adhesive and aggregate material.

### FIELD OF THE INVENTION

The present invention relates to non-skid surfaces and, more particularly, to a kit and method for adding a multicolor, custom-designed, non-skid surface to an existing surface.

### BACKGROUND OF THE INVENTION

There are many places where the addition of a non-skid surface could be beneficial. To that end, many strategies have evolved to provide such surfaces, typically on inclined walkways and the like. Such surfaces usually involve the inclusion of sand or other similar aggregate in a high durability paint. However, these monochromatic approaches have not been found suitable for certain potential applications. One such application is for adding decorative, non-skid surfaces to skateboards, scooters, boats, trucks, pistol grips, walkways, etc.

The skateboard, which in its simplest implementations is nothing more than a thin, horizontal platform suspended above four wheels, has become a ubiquitous part of current culture. Having simple beginnings, contemporary skateboards have evolved, both mechanically and artistically, into sophisticated, intricately decorated vehicles. They are used competitively by some riders to perform almost circus-like feats. This usage demands a non-skid surface on the skateboard so that, while performing these acrobatic movements, the rider's feet stay positioned in a desired spot on the skateboard's surface. The need for a non-skid surface, however, conflicts with the desire by owners and riders of skateboards to customize designs on the board's top surface. A kit containing the necessary materials, along with detailed instructions for the application of a design to a skateboard, is considered highly desirable. While the application of a decorative, non-skid surface to a skateboard is described hereinbelow for purposes of disclosure, it is considered illustrative and not limiting. The method and kit of the present invention may, of course, be applied to any other suitable surface.

### DISCUSSION OF THE PRIOR ART

Many attempts have been made to provide both a multicolor design and a non-skid surface on a skateboard or other surface.

U.S. Pat. No. 6,217,252, for WEAR-RESISTANT TRANSPORTATION SURFACE MARKING METHOD AND MATERIALS, issued Apr. 17, 2001 to Howard R. Tolliver, et al., teaches a sophisticated, flame-sprayed material and a method for its application to a roadway or similar surface. The non-skid material of TOLLIVER, et al., may be used to create center lines, side lines, indicia or similar markings on roadways. While the TOLLIVER, et al., coating may be applied in specific patterns, it is essentially a single-color product. This application involves heating the ambient temperature, melting or otherwise softening a binder material, applying the binder material together with a particulate topcoat to the preheated roadway, and optionally postheating the previously applied material.

In contradistinction, the inventive method requires no heat treatment of either the target surface (i.e., skateboard or other surface) or of the materials to be applied thereto. An adhesive is selectively applied to masked portions of the target surface and a pre-colored aggregate is dispensed onto the adhesive. After the adhesive has reached a desired degree of tack, excess aggregate may be removed. Another region of the target surface may then be treated by applying a different color aggregate. The process may be repeated until the entire target surface is covered with the aggregate. There is no teaching in TOLLIVER, et al., of multicolored aggregates or a suggestion of a kit containing all necessary materials to treat a skateboard or other target surface.

U.S. Pat. No. 5,622,759, for SKATEBOARD GRIP TAPE, issued Apr. 22, 1997 to Marco A. Fuster teaches a non-skid tape for application to the upper surface of a skateboard deck over an existing, pre-applied surface treatment and/or design. There is no provision for creating a multicolor design with the tape. In fact, although the FUSTER tape has an open grid structure, it still partially masks the existing design on the skateboard or other surface.

U.S. Pat. No. 4,921,513, for METHOD OF MANUFACTURING A SKATEBOARD, issued May 1, 1990 to Keith Parten teaches the application of a preprinted label to the upper surface of a skateboard. While the PARTEN label may include a sophisticated, multicolor design, it still must have a protective layer (i.e., a sealant coating) applied. PARTEN suggests a protective layer of lacquer, which fails to provide a non-skid surface. A non-skid tape such as that taught by FUSTER, or other suitable surface treatment, is still required to provide the necessary non-skid surface.

U.S. Pat. No. 3,638,785 for KIT FOR MODIFYING FOOTWEAR TRACTION, issued Feb. 1, 9172 to Charles P. Casteel teaches a kit containing the necessary equipment and supplies for applying a non-skid surface to the soles of shoes or similar footwear. There is no teaching in CASTEEL of materials supplied in multiple colors or of a method for creating multicolor designs. Further, there would be little, if any, motivation to provide multicolor designs on the soles of footwear. There is no suggestion that either the supplies contained in the CASTEEL kit or the application method would be suitable for creating multicolor, non-skid designs on the surface of a structure such as a skateboard or other target surface.

None of these patents, either singly or in combination, either teaches or suggests the possibility of creating a custom, multicolor, non-skid design on a surface such as the deck of a skateboard or similar structure.

It is therefore an object of the invention to provide a kit of materials and a method for creating a custom, multicolor, non-skid design on a target surface.

It is another object of the invention to provide a kit of materials and a method for creating a custom, multicolor, non-skid design on a target surface, which can replace or overlay an existing design.

It is also an object of the invention to provide a kit of materials and a method for creating a custom, multicolor, non-skid design on a target surface, which is easy to use.

It is a further object of the invention to provide a kit of materials and a method for creating a custom, multicolor, non-skid design on a target surface, which is relatively inexpensive.

It is an additional object of the invention to provide a kit of materials and a method for creating a custom, multicolor, non-skid design on a target surface such as a skateboard, which is self-contained and requires a minimum of equipment or tools to use.

It is an additional object of the invention to provide a kit of materials suitable for creating designs of different sizes.

It is a still further object of the invention to provide a kit of materials specifically adapted to creating a design on a skateboard, scooter, skim board, etc.

### SUMMARY OF THE INVENTION

The present invention features a kit and method for applying a custom, multicolor, non-skid design to a target surface. A typical example of such a target surface is the upper surface of a skateboard. The target surface is prepared and a masking layer is first applied. A design is created in the masking layer and the design regions separated according to the final color. Mask sections are selectively removed according to the color being applied. An adhesive is applied to the unmasked surface areas and color aggregate is applied. After an appropriate degree of tack is achieved, a second area is unmasked and the process repeated with a different color aggregate. The process is repeated until the desired design is complete and the entire target surface is covered with a non-skid aggregate, thereby forming the intended design.

### BRIEF DESCRIPTION OF THE DRAWINGS

A complete understanding of the present invention may be obtained by reference to the accompanying drawings when taken in conjunction with the detailed description thereof and in which:

FIG. 1a is a perspective view showing the preparation of the skateboard surface;

FIG. 1b is a perspective view showing the preparation of the skateboard surface;

FIG. 2 is a perspective view showing the application of a mask layer to the skateboard surface;

FIG. 3 is a perspective view showing the edge of the mask being trimmed;

FIG. 4 is a perspective view showing a design being drawn on the surface of the mask;

FIG. 5 is a perspective view showing the mask being cut in accordance with the design of FIG. 4;

FIG. 6 is a perspective view showing a section of the mask being removed from the skateboard surface;

FIGS. 7a-7b show perspective view of the steps in preparing adhesive for use in the method of the invention;

FIG. 8a-8b show perspective views of the steps of applying adhesive to the surface of the skateboard; and

FIGS. 9a-9c show perspective views of the steps of applying aggregate to the surface of the skateboard.

### DESCRIPTION OF THE PREFERRED EMBODIMENT

The following detailed description is of the best presently contemplated modes of carrying out the invention. This description is not to be taken in a limiting sense, but is made merely for the purpose of illustrating general principles of embodiments of the invention.

Generally speaking, the invention relates to a method for applying a custom, multicolor, non-skid design to a target surface such as the upper surface of a skateboard deck. While a skateboard has been chosen for purposes of disclosure, it will be recognized that the inventive process and kit may be used with virtually any surface where a decorative, non-skid surface is desired. A few possible surfaces which may benefit from such a multicolor, non-skid, custom design are scooters, skim boards, sidewalks displaying a business name or logo, and step areas on automobiles, seacraft and aircraft. A kit containing the necessary supplies for applying a design is provided.

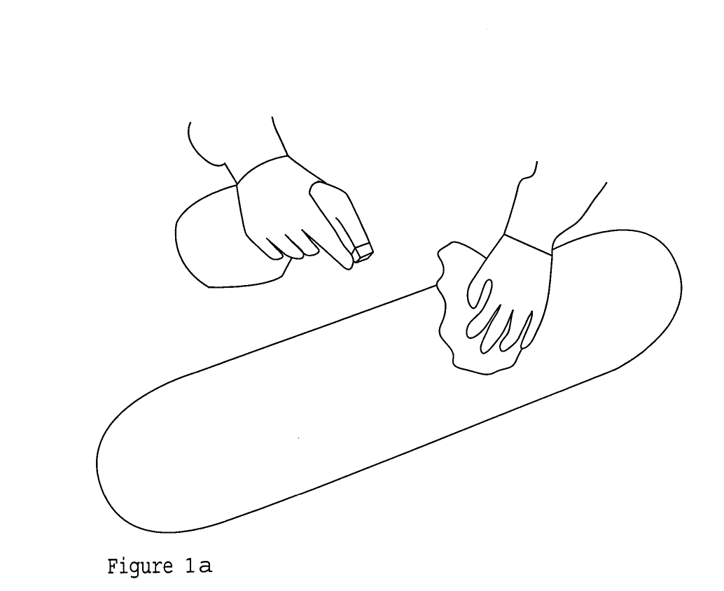

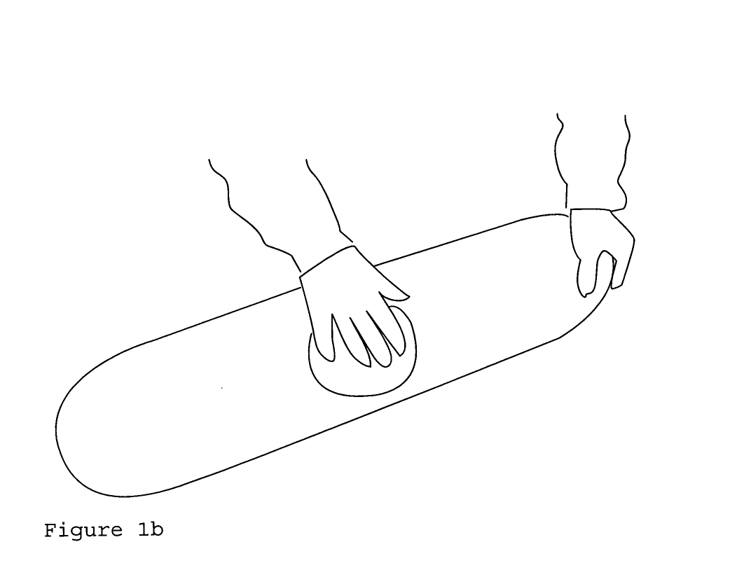

Referring first to FIG. 1a, there is shown a perspective view of the upper surface of a skateboard being prepared to receive the non-skid surface. The existing surface of the skateboard is first cleaned with a degreaser to remove any oil or other substances. Referring to FIG. 1b, the existing surface of the skateboard is roughened using sandpaper, an abrasive block or another suitable material or apparatus. It is assumed that the method of the present invention will be practiced on skateboards having substantially smooth finishes. To ensure proper adhesion, all “shininess” must be removed during the sanding operation. A clean, dry rag or other suitable fabric has been found suitable for wiping the surface. For surfaces other than skateboards, similar appropriate, surface-specific preparation must be performed.

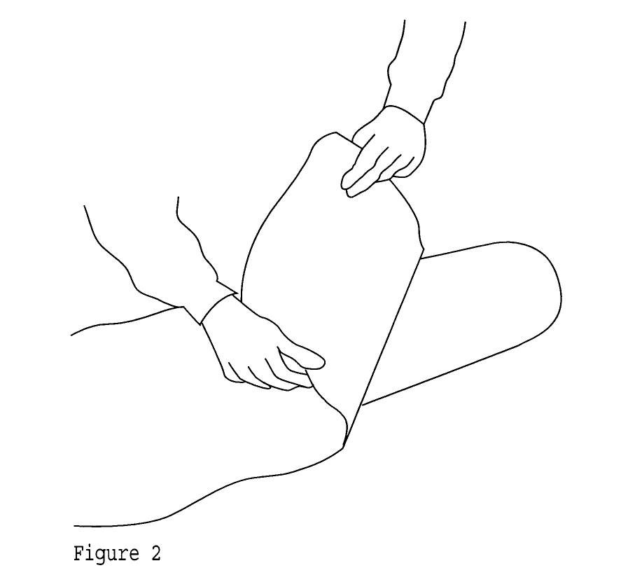

After the upper surface has been roughened and wiped clean, the protective layer is removed from the self-adhesive mask material and the mask material is adhered to the upper surface of the skateboard deck as shown in FIG. 2. The mask is smoothed into place from its center toward its outside edges. This process eliminates most air bubbles trapped between the mask material and the upper surface of the skateboard. Any remaining air bubbles may be removed by puncturing the mask material at the bubble site with a suitable instrument. Other application techniques may be required for surfaces other than skateboards.

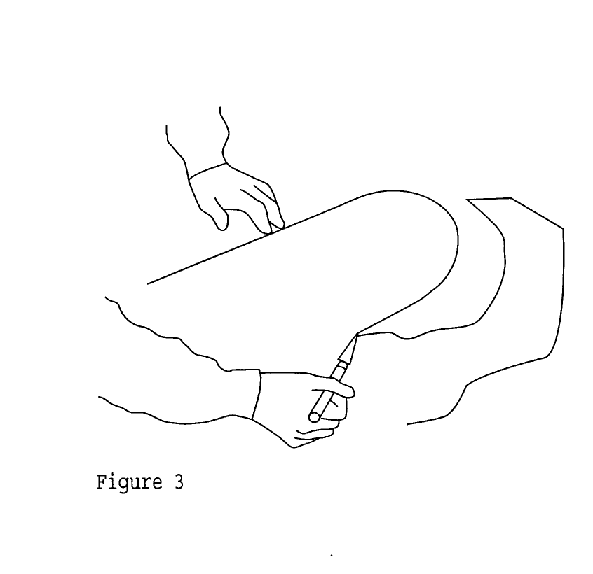

The mask material will typically be supplied in a size bigger than the target surface (e.g., the skateboard, etc.) and, after it has been smoothed into place, the outside edges are wrapped around the edges of the skateboard deck and trimmed with a suitable instrument as shown in FIG. 3. An Xacto® knife has been found suitable for this operation although other similar tools may also be used. For surfaces other than skateboards, other suitable trimming may be performed as required.

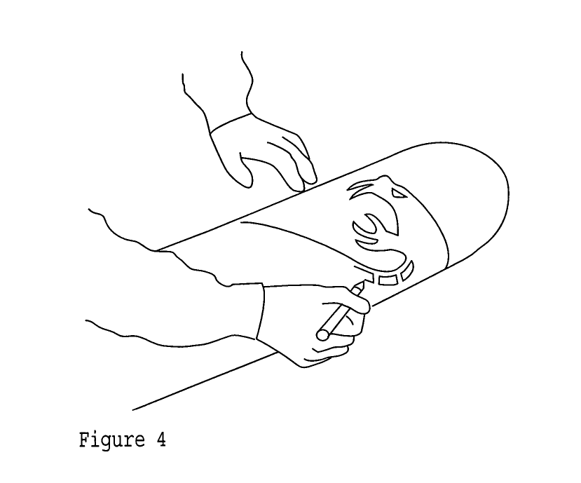

A design is next drawn on the surface of the mask as shown in FIG. 4. Any suitable marking instrument may be used to draw the design.

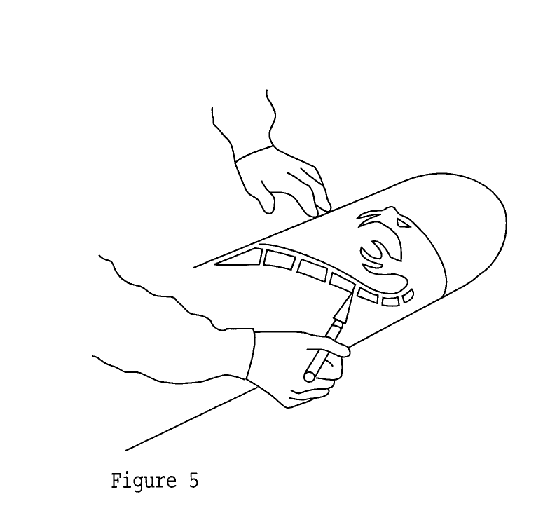

In FIG. 5, the design drawn as shown in FIG. 4 is cut using an Xacto® knife or other suitable instrument. It is recommended that the sections of the mask be labeled according to the color aggregate to be applied to each section. Optionally, a perimeter border, typically of approximately ⅛ inch, may be cut around the perimeter of the skateboard's upper surface. This allows leaving a narrow, untreated margin around the perimeter of the deck of the skateboard. For non-skateboard surfaces, alternate border designs may be used as required or desired.

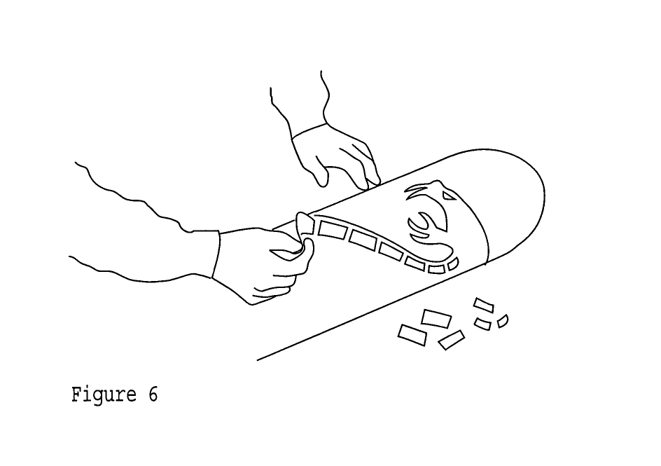

A first section of the mask is next peeled back as shown in FIG. 6. The exposed area may be sanded or otherwise treated again to ensure that a roughened surface is provided for adhesion of the aggregate.

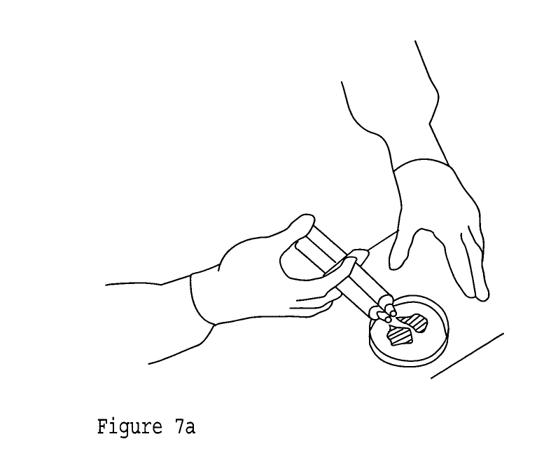

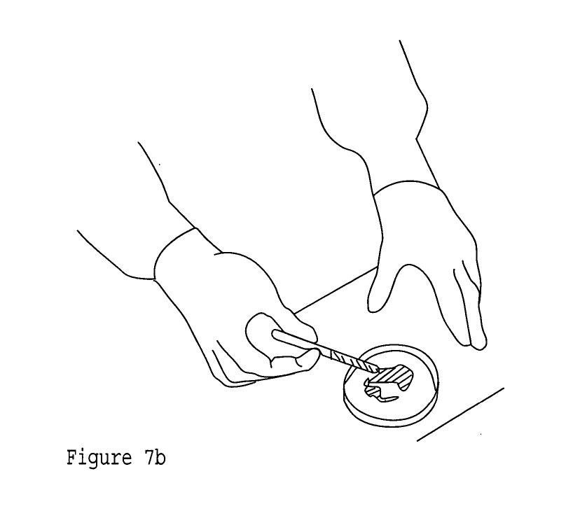

Referring next to FIGS. 7a-7b, typical steps for preparing an adhesive are shown. Typically, a two-part epoxy adhesive is used. The exact preparation steps will vary in accordance with the manufacturer's instructions supplied with a specific adhesive. It will be recognized by those of skill in the art that a wide variety of different adhesive materials could be chosen for securing the aggregate to the target surface (e.g., the skateboard deck). In the adhesive chosen for purposes of disclosure, the adhesive container is opened; adhesive components are injected into a mixing cup (FIG. 7a); and the adhesive is mixed (FIG. 7b).

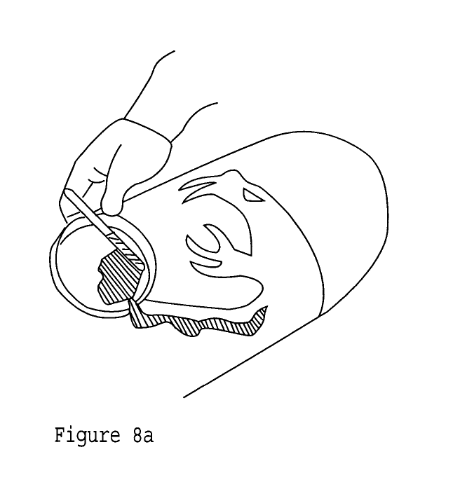

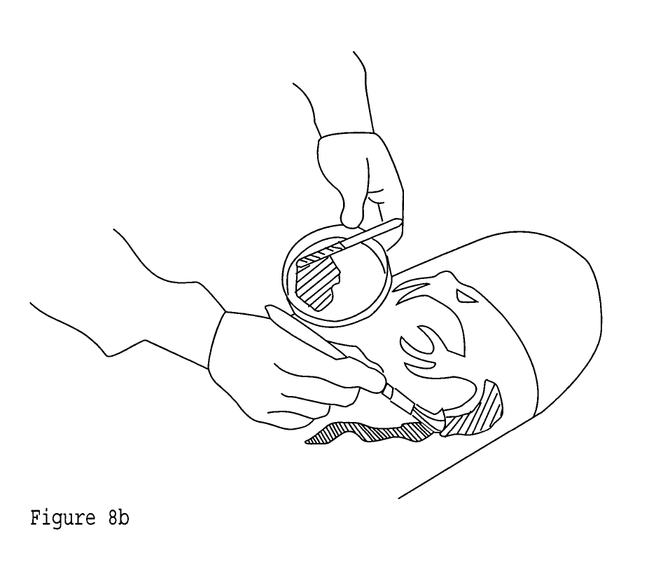

Adhesive is applied to the exposed portion of the skateboard surface (FIG. 8a) and distributed and leveled with a paintbrush (FIG. 8b).

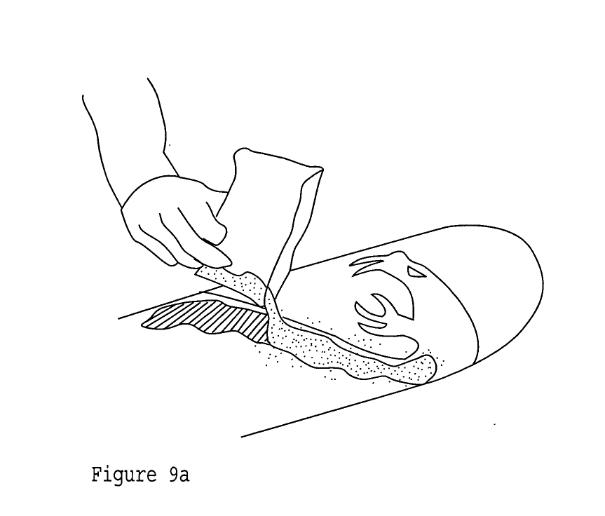

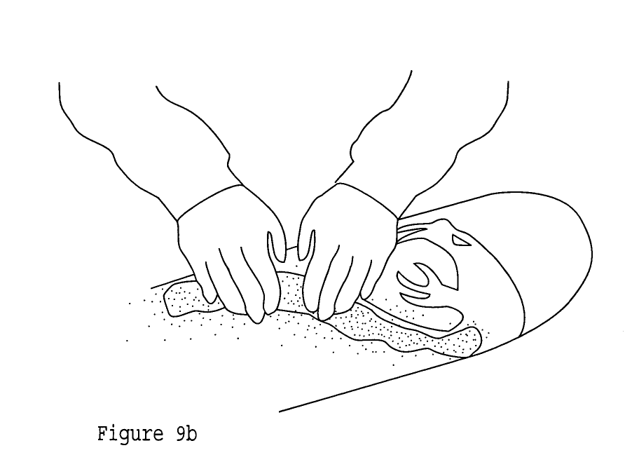

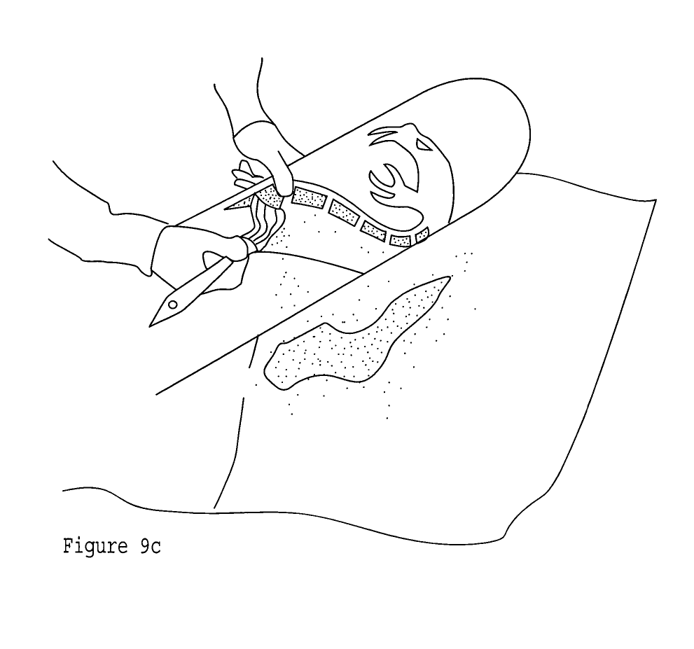

Once a thin, substantially uniform layer of adhesive has been applied, the aggregate of the desired color is sprinkled over the adhesive coated area as shown in FIG. 9a. Either the aggregate can be dispensed from its container or from a container having a screened upper opening to facilitate application of the aggregate. It should be recognized that other suitable application techniques may also be used. After the entire exposed area of adhesive has been coated, the aggregate is pressed down into the adhesive as shown in FIG. 9b. After the adhesive has reached an appropriate degree of tack, approximately 15 minutes for the adhesive chosen for the purpose of disclosure, the excess aggregate may be removed from the target surface of the skateboard by tilting the board and tapping or by some other suitable method. Obviously, for surfaces other than skateboard surfaces, other methods may be used. Typically, the coated area may be lightly brushed and the loose, excess aggregate gathered using a dustpan or other suitable means. The excess aggregate may be caught and reserved for future use.

Another predefined area of the mask is next removed. The edges of existing aggregate regions must be masked using masking tape or its equivalent to ensure that adhesive is not applied to the existing aggregate. This allows forming sharp, well-defined edges between the regions of different colors. The process is repeated until all colors of aggregate have been placed on the upper surface of the skateboard deck. Finally, the thin edge mask, if used, may be removed.

If one or more areas exhibit insufficient aggregate, additional adhesive may be applied to those areas and additional aggregate added as required.

A kit containing the necessary materials and tools for creating a multicolor, custom, non-skid design is provided. The kit contains a suitable adhesive, an adhesive mixing container and mixing sticks, sandpaper or an abrasive pad, colored aggregate in a variety of colors in individual packages, an aggregate applicator, a small and a medium sized paintbrush, masking material, stencils, an Xacto® knife, and an instruction sheet. It will be recognized that modification to the kit contents to meet a particular operating requirement or environment could be made. For example, various sizes of masking material could be supplied and adhesive and/or aggregate supplied in quantities sufficient to create a design of the desired size.

The aggregate may be colored sand such as supplied in a variety of colors in art and hobby stores for use in “sand art” projects. The adhesive may be any suitable two-part adhesive system, such as epoxy.

While the description above refers to particular embodiments of the present invention, it will be understood that many modifications may be made without departing from the spirit thereof. The accompanying claims are intended to cover such modifications as would fall within the true scope and spirit of the present invention.

Having thus described the invention, what is desired to be protected by Letters Patent is presented in the subsequent appended claims.

1. A method for providing a non-skid surface to a target surface, comprising:
preparing the target surface for accepting an adhesive;
applying a mask material to the prepared surface;
providing a plurality of measures of differently colored aggregate material, and for each color of aggregate material provided:
removing a portion of the mask material to expose a portion of the prepared surface;
coating the exposed portion of the prepared surface with an adhesive; and
applying the aggregate material in sufficient quantity to cover the applied adhesive.

2. The method as set forth in claim 1 wherein the target surface is selected from the group consisting of skateboards, scooters, skim boards, sidewalks, steps, boats and aircraft.

3. The method as set forth in claim 1 wherein the target surface is prepared by abrading the target surface with an abrasive material.

4. The method as set forth in claim 3 wherein the abrasive material is sandpaper.

5. The method as set forth in claim 1 wherein the target surface is prepared by:
abrading the target surface with an abrasive material; and
cleaning the target surface.

6. The method as set forth in claim 1 wherein the mask material is applied using a non-permanent adhesive.

7. The method as set forth in claim 1 wherein the adhesive is a two-part epoxy.

8. The method as set forth in claim 1 wherein the mask material includes a pre-scored stencil.

9. The method as set forth in claim 1 further comprising removing excess aggregate material.

10. A method for providing a non-skid surface to a target surface, comprising:
abrading the target surface for accepting an adhesive;
cleaning the abraded target surface;
applying a mask material having a non-permanent adhesive surface to the prepared surface by means of the non-permanent adhesive surface;
providing a plurality of measures of differently colored aggregate material, and for each color of aggregate material provided:
removing a portion of the mask material to expose a portion of the prepared surface;
coating the exposed portion of the prepared surface with an epoxy adhesive; and
applying the aggregate material in sufficient quantity to cover the applied adhesive.

11. A kit for applying a non-skid surface to a target surface, comprising:
an abrasive material;
a mask material;
a means for creating a design in the mask material;
an adhesive;
means for applying the adhesive to the target surface;
a plurality of measures of differently colored aggregate material.

12. The application kit as set forth in claim 11 wherein the abrasive material is sandpaper.

13. The application kit as set forth in claim 11 further comprising a cleaning material.

14. The application kit as set forth in claim 11 wherein the mask material includes a surface having a non-permanent adhesive.

15. The application kit as set forth in claim 11 wherein the means for creating a design in the mask material is a pre-scored stencil.

16. The application kit as set forth in claim 11 wherein the means for creating a design in the mask material is a drawing implement for drawing the design and a cutting implement for cutting out the drawn design.

17. The application kit as set forth in claim 11 wherein the adhesive is a two-part epoxy.

18. The application kit as set forth in claim 11 further comprising a container for preparing the adhesive.

19. The application kit as set forth in claim 11 further comprising a means for applying the aggregate material to the adhesive on the target surface.

20. A kit for applying a non-skid surface to a target surface, comprising: an abrasive material;
a mask material which has a non-permanent adhesive which includes a pre-scored stencil for a design;
an epoxy adhesive;
means for applying the adhesive to the target surface;
a plurality of measures of differently colored aggregate material; and
a means for applying the aggregate material to the adhesive on the target surface.
